(19) United States
(12) Patent Application Publication
(10) Pub. No.: US 2007/0130318 A1
(43) Pub. Date: Jun. 7, 2007

(54) Graphical support tool for image based material

(76) Inventor: Christopher Roast, Sheffield (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/265,448

(22) Filed: Nov. 2, 2005

(51) Int. Cl. G06F 15/173

(52) U.S. Cl. 709/224

(57) ABSTRACT

An analysis tool for analysing a plurality of interconnected pages, said tool comprising a navigation component for navigating said plurality of interconnecting pages an image extraction component for collecting images of individual said pages addressed by said navigation component; and an analysis component for ordering said plurality of page images in a display space according to at least one visual data inherent in each of said page images.

### FIELD OF THE INVENTION

The present invention relates to a method and apparatus for checking visual consistency of web pages.

### BACKGROUND TO THE INVENTION

Conventional websites, particularly large websites having hundreds of individual pages are generated at least in part by a variety of automatic website design packages implemented in software. A problem which web designers are often faced with is that they have to manage a massive data structure which is designed and generated to satisfy a variety of needs. Large websites may consist of thousands of individual pages and hundreds of thousands of links between pages.

To provide consistency, website designers use conventional tools which apply types of abstract encoding, or automated transformation, and/or re-use of images or objects. A website designer may also use tools to check the overall consistency of a website, for example that there are no ‘dead links’ to pages which do not exist. A wide range of known design tool products exists DREAMWEAVER produced by Macro Media (http://www.MacroMedia.com), embodies many of the techniques and concepts conventionally used for website design. The world wide web consortium provides links to variety of automated tools for quality assurance (see: http://www.w3w.org/QA).

These automated software tools can be used to impart a degree of coherence between web pages at the code level. For example such tools may check that the same logo or the same graphic file is used on every page.

There can be a mass of data, the integrity of which needs to be managed, and often there are different types of information on a website, such as promotional publicity material, and technical data about products.

Owners of web sites, when creating a website are often driven by the motivation of presenting a strong branding or visual concept to promote their business. Website owners seek to promote a strong brand image through their websites, which may extend to related web pages or websites accessible via links out of a users website. However, although known website design tools provide some level of consistency of information presented within a web domain specified by the website owner, there are often differences in visual presentation as seen by a user between different pages while browsing. Further, it is a feature of the website design service industry that website designers are always required to reduce cost, and are under pressure of deadlines for design of websites. For websites containing a large number of pages, checking consistency of presentation is a time consuming process, which is often overlooked or not carried out thoroughly, due to constraints of time pressure and cost.

There are also issues about ownership of information, that is, different types of information may be owned or originate from different organizations or sub organizations within a website, for example a marketing department, servicing department, or an accounts department. Within a single corporation each sub organization may want ownership of the content and appearance of their own part of the website.

A further issue is the extent to which generation of a website is automated. If a large number of web pages are to be designed, then automation tools are likely to be used. Consequently, website design becomes similar to running a program. An automated mechanism is set up to design web pages, the mechanism is run, and the designers anticipate that the output of the mechanism will be a consistent set of web pages.

However, such known website design tools do not ensure uniformity or consistency of overall presentation. For example a graphic file or a logo, whilst being the same on each of a set of web pages, may be positioned differently, or may be placed in the context of different backgrounds, which gives the overall effect of an inconsistent presentation.

Consequently, using known website and web page design tools, large websites can be created, in which a style of presentation between different web pages is different or inconsistent.

Known website and web page design tools do not provide a facility for managing coherence of visual presentation between different web pages within a domain.

Existing known tools and techniques are focused solely upon the top-down control and analysis of the source coding of web material, such as HTML.

### SUMMARY OF THE INVENTION

Specific implementations according to the present invention may provide a tool and method for enabling a user to make an assessment of the visual coherence of a plurality of pages in a domain comprising and/or accessible through a website.

Suitably, the tool is characterised by operating on a visual appearance of a plurality of web page images, rather than upon an underlying program code by which one or more web pages are created.

Suitably, the tool operates by following browsable routes, and the output of a browser. The tool may be driven from the output of a browser.

The method provides a systematic review and analysis of web based material focusing upon the screen images when browsing material.

Specific implementations according to the invention may provide a mechanism for assessing a visual coherence of pages for arbitrary web based material, by automatically following web links and by constraining the scope of material examined by consideration of visual characteristics of pages as presented to a user browsing such material. The resulting retrieved pages can be presented to web developers, authors and clients as a map indicating visual similarities and diversity. Such a map supports informal quality assessment processes concerned with the visual identity and branding of web material.

Specific implementations disclosed herein comprise a quality assurance tool—effectively a de-bugging tool, which can be used either by a web designer, or a customer of a web designer to check a web designer's work.

According to one aspect of the present invention, there is provided a method for checking visual consistency of a plurality of pages, said method comprising:

browsing a plurality of interconnected pages;

for each browsed page, collecting an image data;

analysing said plurality of page images to determine a relative similarity between each of said plurality of pages; and

displaying said plurality of page images in a display space, with said images positioned in said display space according to their common features.

According to a second aspect of the present invention, there is provided an apparatus for checking visual consistency of a plurality of pages, said apparatus comprising:

a browser for browsing a plurality of interconnected pages;

means for collecting image data of said browsed pages;

means for analysing a plurality of page images of said browsed pages, to determine a relative similarity between each of said plurality of pages; and

display means for displaying said plurality of page images in a display space, such that said images are positioned in said display space according to a set of common features.

The invention includes a computer program comprising program instructions suitable for causing a computer entity to operate for checking visual consistency of a plurality of pages by:

browsing a plurality of interconnected pages;

for each browsed page, collecting an image data;

analysing said plurality of web page images to determine a relative similarity between each of said plurality of web pages; and

display said plurality of web page images in a display space with said images positioned in said display space according to their common features.

According to a third aspect of the present invention, there is provided an analysis tool for analysing a plurality of interconnected web pages, said tool comprising:

a navigation component for navigating said plurality of interconnecting web pages;

an image extraction component for collecting images of individual said web pages addressed by said navigation component; and

an analysis component for ordering said plurality of web page images in a display space according to at least one visual data inherent in each of said web page images.

According to a fourth aspect of the present invention, there is provided a method of analysing a plurality of interconnected web pages, said method comprising:

navigating said plurality of interconnected web pages;

extracting images of individual said web pages encountered during said navigation;

collecting a set of said extracted web page images; and

ordering said set of extracted web page images in a display space according to at least one visual parameter inherent in each of said extracted web page images.

According to a fifth aspect of the present invention, there is provided a visual display generation means, comprising:

means for generating a 2-dimensional visual display screen;

means for assigning a first parameter to a first position axis of said display;

means for assigning a second parameter to a second position axis of said display; and

means for assigning a plurality of web pages to said 2-dimensional visual display screen, according to a relative position of each of said web pages along said first and second position axes.

According to a sixth aspect of the present invention, there is provided a method of assigning web pages to a 2-dimensional screen display, said method comprising:

generating a 2-dimensional visual display;

assigning a first parameter to a first position axis of said display;

assigning a second parameter to a second position axis of said display; and

assigning a plurality of web pages to said 2-dimensional display, according to a relative position of each of said web pages along said first and second position axes.

The invention includes a computer program comprising program instructions for causing a computer entity to:

generate a 2-dimensional visual display view;

assign a first parameter to a first position axes of said display view;

assign a second parameter to a second position axes of said display view; and

assign a plurality of web pages to said 2-dimensional display view according to a relative position of each of said web pages along said first and second position axes.

According to a seventh aspect of the present invention, there is provided a method of visualising a domain comprising a plurality of web pages, said method comprising:

collecting a plurality of images from said domain;

positioning said plurality of images in a display space, wherein a position of each said image in said display space is determined by a visual content of said image; and

displaying said plurality of images according to their positions in said display space.

The invention includes a computer program comprising program instructions for causing a computer entity to visualise a domain comprising a plurality of web pages by:

collecting a plurality of images from said domain;

position said plurality of images in a display space, wherein a position of each said image in said display space is determined by a visual content of said image; and

display said plurality of images according to their portions in said display space.

According to an eighth aspect of the present invention, there is provided a method of collecting a plurality of web pages in a web domain, said method comprising:

following a plurality of links from at least one initial web page;

downloading a web page image of at least one collected web page; comparing a visual feature of said downloaded web page with collected web pages; and

determining from said comparison of visual features of said downloaded web page with collected web pages, whether or not to follow a link from said downloaded web page.

The invention includes a computer program comprising program code instructions for causing a computer entity to operate for:

following a plurality of links from at least one initial web page;

downloading a web page image of at least one encountered web page;

comparing a visual feature of said downloaded web page with collected web pages; and

depending upon a visual similarity of said collected web pages and said downloaded web page determining whether or not to follow a link from said downloaded web page to at least one further web page.

According to a ninth aspect of the present invention, there is provided an apparatus for analysing a plurality of web pages in a web domain, said apparatus comprising:

a URL storage component for storing at least one URL of an initial web page; and

an analysis component for comparing a visual feature of said downloaded web page with collected web pages.

According to a tenth aspect of the present invention, there is provided a method of analysing a plurality of pages in a domain, said method comprising:

identifying a parameter which is common to said plurality of pages; and

assigning said parameter to a dimension in a display space.

According to an eleventh aspect of the present invention, there is provided a method for checking a visual consistency of a plurality of interconnected pages, said method comprising:

browsing said plurality of interconnected pages;

for each individual page, collecting a sequence of a plurality of images from said page;

analysing a plurality of collected image sequences collected from a plurality of said pages; and

displaying said plurality of page images in a display space, with said images positioned relative to each other in said display space according to the similarities of their respective image sequences.

According to a twelfth aspect of the present invention, there is provided a computer program comprising program instructions for causing a computer entity to: for each of a plurality of individual pages, collect a dynamic sequence of a plurality of images from said page;

analyse a plurality of collected dynamic image sequences collected from said plurality of pages; and

display a plurality of page images in a display space, with said page images positioned relative to each other in said display space according to the similarities of their respective dynamic image sequences.

According to a thirteenth aspect of the present invention, there is provided a computer program comprising program instructions for causing a computer entity to create a display which arranges a plurality of interconnected pages according to visual parameters exhibited by those pages.

Other aspects of the invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a visualisation tool for assessing visual consistency of a web domain;

FIG. 2 illustrates schematically a visualisation tool embodied as a computer entity;

FIG. 3 illustrates schematically components of a visualisation and analysis module comprising the visualisation tool of FIGS. 1 and 2;

FIG. 4 illustrates schematically in overview, processes carried out by the visualisation tool;

FIG. 5 illustrates schematically processes carried out by the visualisation tool for collection of a set of linked web pages from a web domain;

FIG. 6 illustrates schematically an example of a first display output of the visualisation tool of FIGS. 1 to 3; and

FIG. 7 illustrates schematically a second example of a display output of the visualisation tool of FIGS. 1 to 3.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

In this specification, the term ‘domain’ means a set of pages which are connected by a set of links. Within a domain, any individual page is connected by a link to another pages within the domain, and any page within the domain can be shown to be connected either directly, or indirectly, by one or a plurality of links, including where appropriate, links to intermediate pages.

In this specification, the term ‘image’ means a viewable image which is presentable on a page. A page may contain one or a plurality of different images, which may occupy different areas of the page, or in the case of a dynamically changing sequence of the images, a same or overlapping area of a page.

Images may include animations, flash introductions, banners, and/or images which may be time division displayed, i.e. alternating between two or more different images occupying a same area of a page. Sequences of images may be displayed on a page. An image may occupy the whole viewable area of a page, or may occupy an area which is a viewable portion of a page.

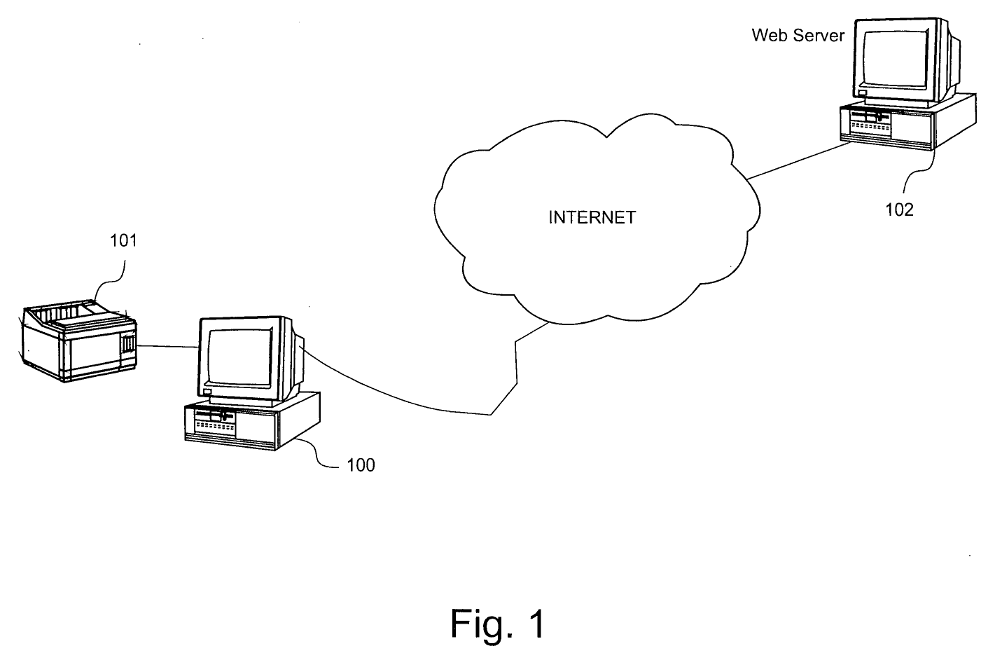

Referring to FIG. 1 herein, there is illustrated schematically a computer entity 100 and printer device 101 configured as a page visualisation and analysis tool, for analyzing web pages of one or more web sites accessible over the internet 102, and/or a wide area network (WAN), a large area network, or an intra net. The web pages are served by one or more web server computer entities 103.

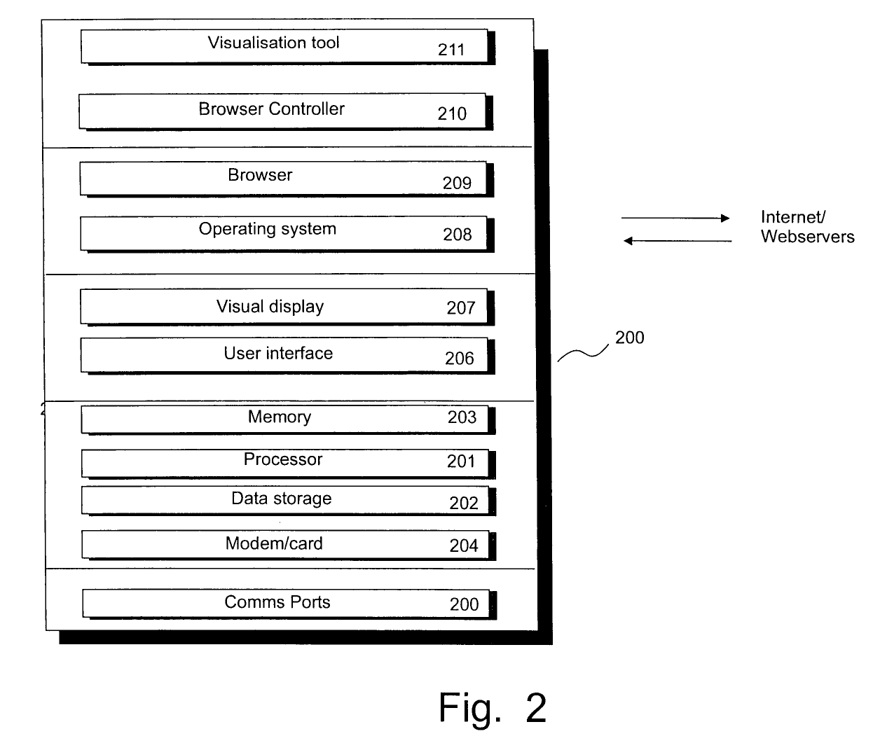

Referring to FIG. 2 herein there is illustrated schematically components of a visualisation and analysis tool. Computer entity 200 comprises; a known data processor 201, one or more data storage devices 202 for providing data storage; a known memory device 203; a known modem or communications interface card 203; a known communications port 204, for communicating with one or more web servers over a communications network, for example the internet; a known user interface 206 and visual display device 207 for enabling a user to enter commands, and to view a set of displays; a known operating system 208, for example Microsoft NT, Microsoft XP, Linux, or MAC OS; a known browser device 209; optionally a known browser controller 210 configured for following links from web page to web page and a visualisation component 211 for performing acquisition, analysis and display of a plurality of web pages within a domain of interconnected web links.

The visualisation component 211 may be embodied as program code instructions stored on a device capable of storing electronic signals, for example a data storage carrier, a memory device, a hard disk drive or the like. The visualisation component may subsist independently on a data storage carrier such as a CD ROM, tape device, or other data storage medium or may be carried as electrical signals over a connection, such as an internet connection carried on copper wires, or via a wireless connection, or be carried as optical digital signals over an optical transmission medium such as a fiber optic cable.

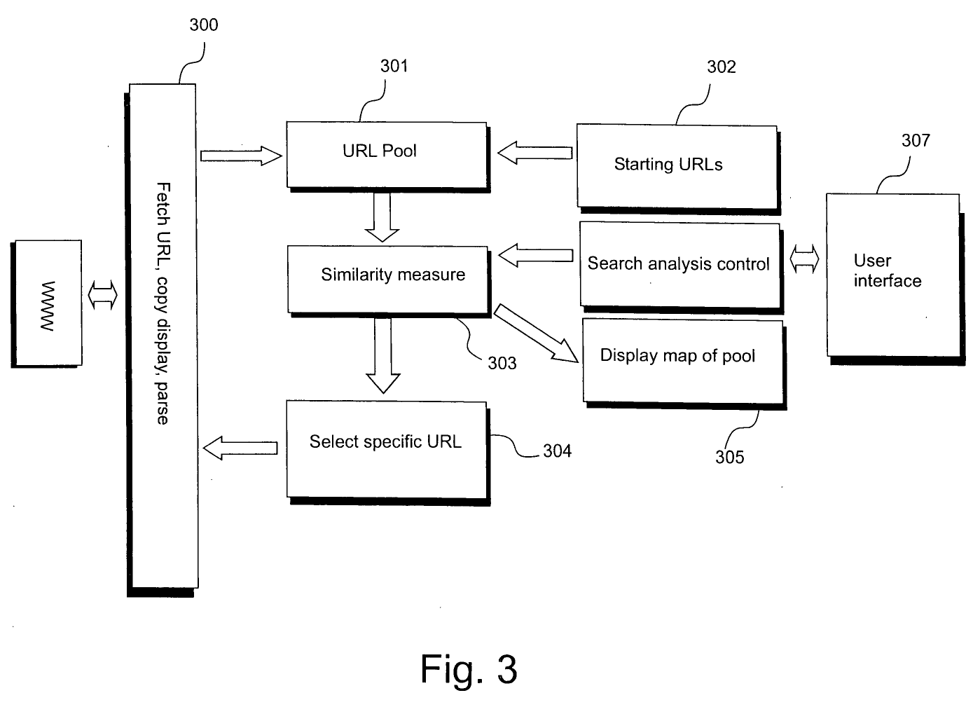

Referring to FIG. 3 herein, there is illustrated schematically components of the visualisation component according to a specific embodiment of the present invention. The component comprises a fetch component 300 for fetching web pages from one or more browser devices; a URL 301 used for collecting a plurality of web page images, for example in the form of thumbnail images, a set of starting URL's 302; a similarity analyser 303 for analysing the similarity between a plurality of web page images; a selection component 304 for selecting web pages; a display generator component 305 for generating a visual display comprising a plurality of web page images; a search and analysis control component 306 for controlling the search of a website, and analysing a set of images retrieved as a result of a search; and a user interface 307 for allowing a user to select parameters for display of visual images on a display device Overview of Operation The tool operates by following browsable routes, and by analysing web pages provided by a browser. Further, the tool is not bound to any single website, or to any particular domain. Therefore, if it is likely or reasonable for a user to drift away from a particular website, for example by following a link embedded in the website, then the analysis tool may follow that route, and download web pages displayed via that route.

A website is designed and constructed in conventional manner. Prior art web analysis tools may be used for checking conformance to formalised standards, such as the consistent use of approved fonts, style sheets, and graphics throughout the website. However, the prior art web analysis tools cannot be used to check that users browsing the material contained in the website will experience an intended visual branding.

A user of a visual analysis tool as described herein may apply such a tool to review the appearance of pages on the website, and to validate a generated visual branding presented by the website as a whole.

A display which plots a plurality of web page images in 2-dimensions is inspected by the user. Particular pages may appear as ‘outliers’, outside a relatively higher density clustering of web pages on the display. These outlier pages may be examined in greater detail visually, for example the outlier pages may adhere to a formal style, but be at odds with an intended visual appearance involving for example, title banners, which may be longer than envisaged, or extra ordinary content which has been mis-encoded. Scripts or styles that generate the page may be enhanced to accommodate such unforeseen cases.

The display may also make visually apparent clusters of pages, which reflect a sub-branding of groups within an organisation. Using such an analysis, presented visually by the analysis tool, it may be apparent to users that close similarity of 2 specific groups of pages occurs, which may prompt the users to review the branding to apply a greater discrimination between 2 sub brands within the website so as to prevent users of the website confusing the 2 sub brands.

The analysis tool may be used to continue to monitor and assess the integrity of a website, retrospectively after the site has been accepted and is commissioned. For example, where a new outlier page appears, this may in fact turn out to be a ‘splash page’ for a new product. The splash page may have its own unique visual identity within the website, and this may be exactly what a marketing department had in mind when generating the splash page. The analysis tool may be used to confirm to the marketing department, that the splash page has the desired effect of being distinct from a main branding and main presentation style provided by the website.

The analysis tool may also be used to find ‘loop holes’ in a website. A loophole is when a number of links from the website direct to a third party website which has a similar visual branding. As a result of finding a loophole, a web design team may decide that they will ‘ring fence’ their site by ensuring that all outside links are reached via page which clearly indicates an exit from the present website.

The analysis tool may also be used to assess a web identity of websites of competitor companies. A degree to which a competitor is duplicating or copying an overall visual appearance or branding can be relatively easily identified using the visual analysis tool.

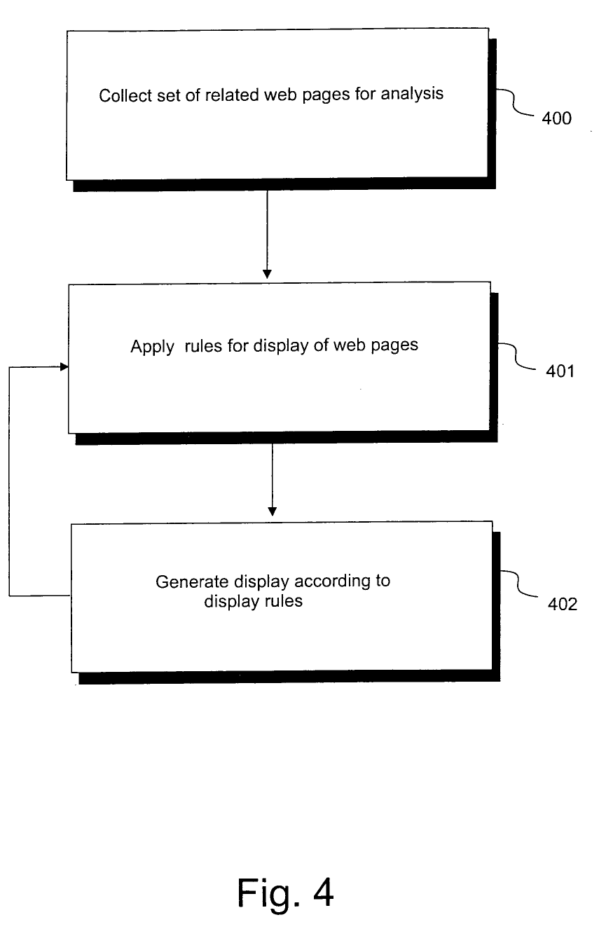

Referring to FIG. 4 herein, there is illustrated schematically overall process stages performed by the analysis tool of FIG. 1. In process 400 a set of related web pages are collected for analysis by the tool. These web pages are selected by a user of the tool as representing or embodying the visual character and/or style of the domain, which a user wishes to achieve. The web pages can be collected as full images, or as thumbnail images. Collection is by way of a conventional browser.

Having established a set of ‘seed pages’, the tool continues automatically to collect pages, and to repeatedly expand a set of collected web pages by following links between web pages within a domain.

Conventional programs are available for automatically following links and browsing a website and/or the Internet. Having collected a set of related web pages for analysis, in process 401 the analysis tool applies a set of rules to the visual appearance of the web pages, in order to identify similarities between pages. When a large enough set of pages are collected, the tool filters those web pages for display. Newly collected web pages are checked for similarity with an initial collected set of web pages, and provided that the newly collected web pages are sufficiently similar to the initial web page set, collection of further web pages by following links from the downloaded web pages is continued. However, if the newly collected web pages, when tested are found to be dissimilar to the initial set of web pages, then there is no further collection of web pages emanating from the newly collected web page. In process 402 a display is generated according to the display rules applied in process 401 and can be displayed on a visual display device, such as a video monitor, and/or by hard copy printout.

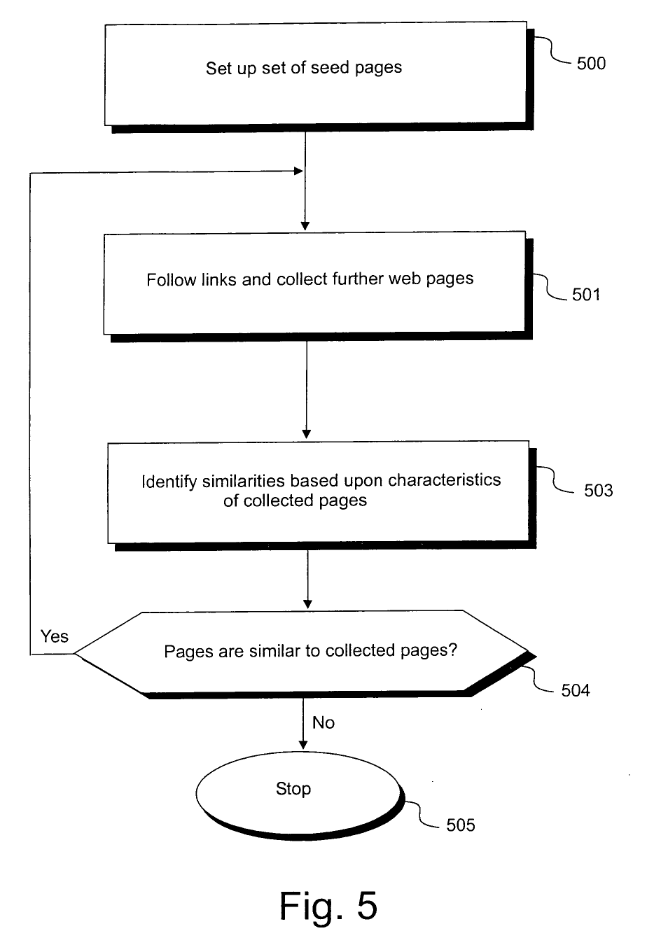

Referring to FIG. 5 herein there is illustrated schematically a website analysis process using the analysis tool. The process establishes a set of web pages for display and analysis. In step 500, a user starts off with a set of ‘seed’ pages, which represent a core concept and visual identity of a website, and which is the intended and desired visual representation which is to be conveyed by a website. An example of a seed page could be the home page of a website.

In process 501, the seed pages are expanded by collecting further web pages from the website. The further web pages are identified by following links from the seed pages. In process 503, there are identified similarities based upon the visual characteristics of the collected web pages. In process 504, if the newly collected pages are similar to the seed pages, that is, if they have sufficient similarity as tested in process 503, then the tool proceeds to follow more links and collect further web pages until the new web pages being collected fail the similarity test in process 503 and are deemed dissimilar to the seed pages in process 504, at which point collection of further web pages ceases 505 at that point, the pages being collected no longer have sufficient similarity to the original seed pages.

User Session

A user session is commenced for checking the visual consistency and overall visual presentation of a web site, including links from the site. Within a user session, the tool may operate in an image collection mode for collecting a set of web page images, and may also operate in a display and analysis mode in which a user can manipulate a visual display, and perform analysis of a set of collected web page images.

Within a user session, a user can select a different display according to a different set of rules applied to a collective set of web pages, store displays, and modify the rules for display of web pages to generate new displays upon the same collected set of web pages. Within a user session, a user may also be able to expand or augment the collected set of web pages by further searching and collection.

Various in screen tools are provided for manipulation of web page thumb nail images on screen, and for selecting sets and/or sub sets of thumb nail web pages having similar visual characteristics for further analysis using pre-determined sets of display rules.

Page Collection

There will now be described a page collection mode of the tool.

A search component fetches a URL a specified by a human operator in order to commence a session. A conventional browser is directed to a web site having the URL, and a web page, for example, a homepage, is displayed. The design tool extracts a thumbnail image of the displayed web page and temporarily stores it. The thumbnail image is a representation of displayed web page, other web page features relevant to visual identity may also form the representation on which the analysis tool relies. For instance, pages that include animation may be represented by a sequence of individual images and any subsequent analysis may be based upon images from that sequence collectively or individually.

The design tool follows a link from the web page, to another web page of the same (or a different) web site, and the browser displays a further web page.

Again, a thumbnail image of the new web page is extracted by the design tool and stored temporarily. This process is repeated, following further links from the currently displayed web page, until a sufficiently large sample of thumbnail images has been collected, for a plurality of web pages which are interconnected.

The precise search routine which the design tool follows can be pre-programmed automatically or can be directed with some user input via the user interface. The exact search routine and the method of its control are implementation specific details.

Analysis and Display

There will now be described an analysis and display mode of the tool.

Once a set of thumbnail images have been collected, the tool can perform various types of analysis on those images. Each thumbnail image may be analysed according to one of more parameters, by a set of modules within the design tool specifically for this purpose. Examples of parameters may include: the hue, brightness and colour saturation of specific regions within an image; the proportion of such factors within and between regions of an image; the presence, absence and/or position of computationally recognisable patterns within an image (such as logos); the degree of presence of user specified textures, colours or patterns (such as corporate colours, skin tone, or logo) within an image. A wide range of search parameters may be programmed, each as different modules.

The design tool filters and selects the thumbnail images according to the one or more parameters. Each parameter can be assigned to a separate dimension in a multi-dimensional display space.

For example in a two dimensional visual display, on the x-axis, there may be a assigned a percentage of ‘blue’ coloration (with specified limits) i.e. 0-100% left to right. On the vertical axis (y-axis), there may be assigned a number of individual text letters on a page, thereby indicating the amount of writing on a page. Thus, a two-dimensional visual display-plotting amount of blue colouration on the x-axis, against density of text on the vertical axis may be presented. This is only one of a wide variety of possible 2-dimensional displays having axes assigned to different parameters.

Further, other types of display are possible, for example 1-dimensional, 3-dimensional or other multi-dimensional displays.

A human user can gain a visual appreciation of the self-consistency of presentation amongst a set of web pages in a web site, by viewing the multi-dimensional displays. Strong clustering of thumbnail images of the visual display indicates a relatively higher level of coherency in the visual presentation of a set of web pages. A wide spatial spread of thumbnail images of the display indicates relative inconsistency of presentation of web pages on a web site.

Identification of Seed Material

The tool operates by comparing images with a set of user selected URLs which link to “seed” pages containing seed material. Seed material is image material which is selected by the user as having a visual content on which the user wishes to base their session. Seed material can include a set of seed pages, in which case seed images comprise the whole viewable area of a page, and/or can comprise one or more images contained within one or more pages. The seed material may act as the basis for the collection of, and comparison between web pages.

In one mode of operation, in a page collection mode, a user may identify a set of web pages as being the seed material for collection of further web pages.

In another mode of operation, a user may identify, for example using a pointing device and screen icon, a region or area of a viewable page which is to be selected as forming a seed image. The seed image can itself be an identifiable image, such as a logo, banner or the like.

The seed material can be a sequence of images, for example a time division displayed sequence of individual images, for example images which are displayed alternately or sequentially within a web page. In this case, subsequent analysis and searching of pages is based on the seed pages.

Output

The output of the tool comprises a mapping of a plurality of thumbnail images of the pages visited, with a distance between the pages being proportional to a visual similarity between the pages, or being proportional to the visual dissimilarity between pages.

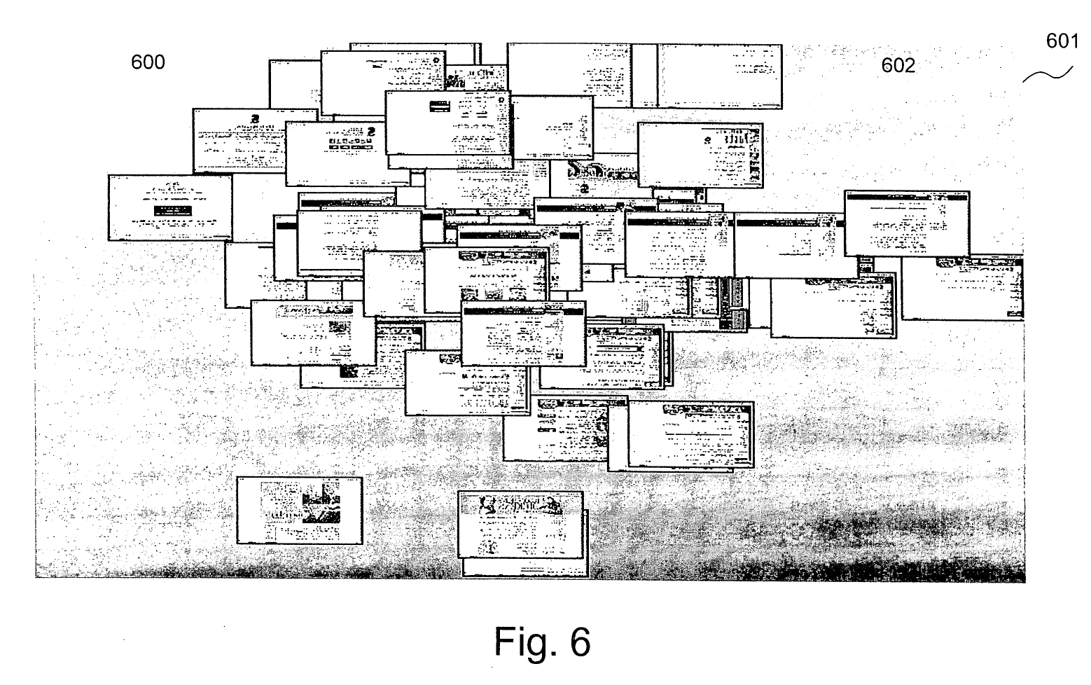

Referring to FIG. 6 herein, there is illustrated schematically one example of a visual display output of the visualization and analysis tool described herein. The display comprises a plurality of thumbnail images of pages, arranged 2-dimensionally. On a first axes, for example a horizontal axes, pages are positioned according to a first parameter. On a second axes, in this case a vertical axes, the web pages are positioned according to a second parameter. The parameters may be selected by a user. For example in the display shown in FIG. 6, the first parameter (x-axes) may be assigned as the percentage of area of a web page which is assigned to a particular colour, for example blue. The second, vertical axes may be assigned a second parameter, for example the percentage of area of a web page which uses the width of the page image, in the examples shown, the highest usage of page width present at the lower end of the display screen, and the lowest use of the page's width being displayed at the upper end of the screen as viewed.

In the general case, although the display device itself presents, a 2-dimensional display view, the view can contain images in a single and/or multi dimensional display space, and is not limited to a 2-dimensional display space, but the display space may be multi-dimensional.

For example, the visual display may display a 3-dimensional display space, in which thumbnail images are presented in perspective view giving a 3-dimensional effect, where each dimension in the 3-dimensional display space is assigned a different parameter.

Parameters which may be assigned to individual dimensions of the display space include but are not limited to the following (and their composites):

Colour—a density of an individual colour (0-100%) may be assigned to a dimension;

Colour—average or dominant hue, brightness and/or saturation may be assigned to a corresponding respective dimension;

White area—a percentage of white (or any other selected colour) area as a percentage of the whole web page area may be assigned to a dimension in the display space;

Pattern match—the extent to which a computational match between image and a specified “sample” can be found may be assigned to one or more dimensions;

Feature extraction—a numerical occurrence of a particular automatically recognizable feature (such as a banner or logo) may be assigned to a dimension;

The skilled reader will appreciate that in general, any automatically visually distinguishable feature of a web page may be assigned to a dimension of the display space.

Overlaying of Thumbnail Images

Referring again to FIG. 6 herein, individual thumbnail images are shown as displayed overlaying each other as viewed by a user of the display. In a further feature of the display interface, a user may select an individual image, for example by moving an on-screen cursor over the selected thumbnail, and activating a mouse switch (or another pointing device, for example a track ball device), which causes the selective thumbnail to be presented at the ‘front’ of the screen, i.e. as a top overlay. In this way, a user may investigate clusters of closely spaced images, so that the user can view and visually inspect the visual content of those thumbnail images individually, and make mental interpretations and assessments of each individual thumbnail image, without a view of that image being obscured by other thumbnail images positioned close with the selected thumbnail image in the display space.

Dimension Reversal and Zooming

The user interface may comprise a facility for reversal and zooming of axes along each dimension of the display space. For example, referring to FIG. 6, the horizontal axes may be assigned as the left hand side of the screen being zero ‘white content’ and the right hand extreme of the screen being assigned as 100% ‘white’ content. In a similar manner, the mass of images displayed may be explored the user by zooming in to specific regions of the axes. The axes may be zoomed, so that 50% white content of a thumbnail image may be assigned to a left hand side of the screen, and 20% white content assigned to a right hand edge of the screen.

Dimension Substitution/Interchange

Individual dimensions in the multi dimensional display space may be assigned to dimensions on the physical display screen. For example on an X-axes of a display screen, a first dimension may be assigned (for example the dimension representing percentage white content), and on a vertical axis of the display screen, a second dimension may be assigned (for example representing percentage blue content). The first and second dimensions may be re-assigned to the axes of the display screen, i.e. swapped over, so that percentage blue content is positioned on the horizontal axis of the display screen and percentage white content is positioned on the vertical axis of the display screen.

Dimensional Geometry

Dimensions need to be linear dimensions extending in a straight line when assigned to a display screen. Dimensions may be radial, for example distance may be measured radially from a centre point on a display screen. It would be appreciated by those persons skilled in the art that a range of mathematical dimensions may be applied in the display space, provided these displays translate to give a discernible presentation on a 2-dimensional display screen, or are printable on a sheet media by a printer device.

Spatial dimensions in the display need not be proportionally linear. For example a logarithmic scale may be assigned to a dimension.

Clustering

Referring again to FIG. 6, there is shown that in some regions of the display screen, a higher density of thumbnail images exists. Clustering of thumbnail images in a particular region represents that the thumbnail images have high visual similarity according to the parameters selected for analysis. The analysis component may comprise a feature for defining a region of the display space around a cluster.

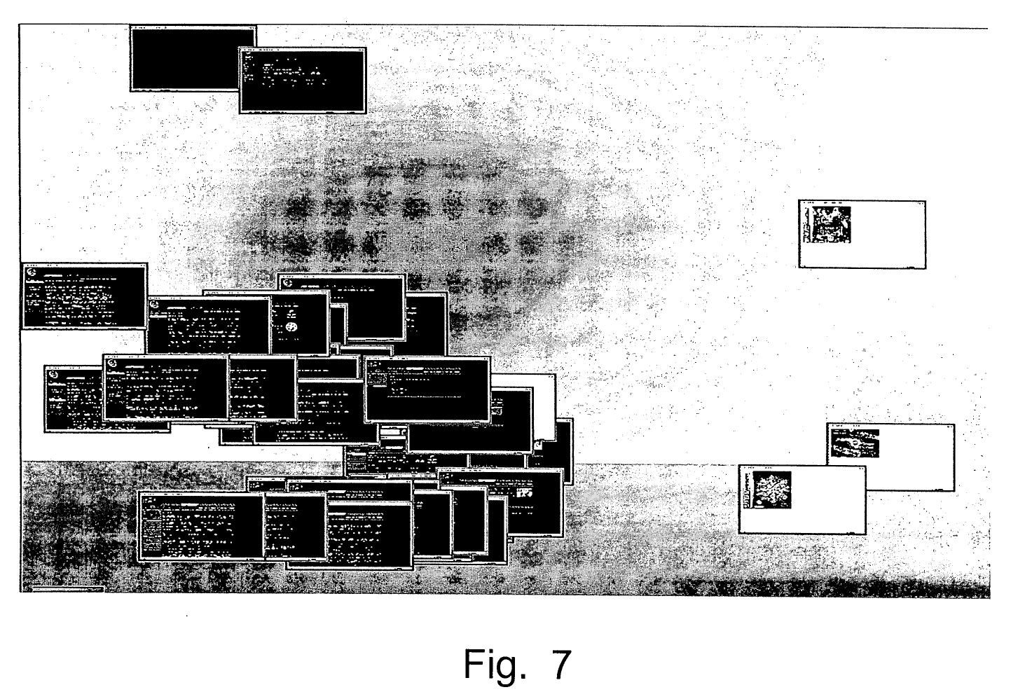

Referring to FIG. 7, there is illustrated schematically an example of a user defined region, the inner rectangle 701 defined by a user using the display interface. A cluster of web pages exist within a defined region Corresponding to the original set of ‘seed’ pages in displayed. On a periphery of the user-defined region, individual ‘outlier’ thumbnails are present, these thumbnails having visually different characteristics to the main cluster of images.

The user interface may comprise other facilities to manage clustered outputs, these may include: (i) the scaling of thumbnail images so as to not overlap as much (ii) the laying out of thumbnail images that directly overlap each other in manner that visually indicates multiplicity of images.

Page Filtering

An analysis tool may comprise a component which allows a filtering of pages in a set, so as to allow visualisation of a remaining subset of thumbnail images left after a set of thumbnail images have been filtered from a domain. For example where a domain comprises a plurality of web pages, some of which have an orange coloration, and a user wishes to visualise a conformity of visual consistency between those orange pages, a filter to select orange coloration may be applied to all web pages, and only web pages having an orange content are viewed. This may ‘thin out’ the density of pages displayed in a display space, to concentrate on one particular feature of a web page (in this example being of an orange coloration).

Various types of filter may be provided including filters for filtering on the basis of any of the image analysis functionality employed including coloration; shading; pattern matching content, etc.

Specific implementations described herein may have the following advantages:

The implementations may provide a visualisation tool which operates on visual images, rather than information content.

The implementations disclosed herein may provide easy and immediate visualisation of a set of web pages by a user.

The implementations herein may provide semi automated checking of an overall presentations of an effect of a website. Automatic highlighting of any web pages which do not conform to the overall presentation of a web site, in a manner which is easy for the user to visualise.

The implementations disclosed herein may provide automatic highlighting.

There will now be described a further example of operation of a specific embodiment analysis tool in the context of assessing a data driven website intended to have consistent visual corporate branding.

1. A method for checking visual consistency of a plurality of pages, said method comprising:
browsing a plurality of interconnected pages;
for each browsed page, collecting at least one image data;
analysing said plurality of page images to determine a relative similarity between each of said plurality of pages; and
displaying said plurality of page images in a display space, with said images positioned in said display space according to their common features.

2. The method as claimed in claim 1, wherein said browsing comprises following browsable routes within a domain.

3. The method as claimed in claim 1, further comprising:
generating a visual display which displays said plurality of page images according to at least one, parameter.

4. The method as claimed in any one of the preceding claims, further comprising:
providing a visual display of said plurality of page images by multi-dimensional visual display of said plurality of page images, wherein said page images are placed in multi-dimensional space depending upon a plurality of common parameters of said page images.

5. Apparatus for checking visual consistency of a plurality of pages, said apparatus comprising:
a browser for browsing a plurality of interconnected pages;
means for collecting image data of said browsed pages;
means for analysing a plurality of page images of said browsed pages, to determine a relative similarity between each of said plurality of pages; and
display means for displaying said plurality of page images in a display space, such that said images are positioned in said display space according to a set of common features.

6. A computer program comprising program instructions suitable for causing a computer entity to operate for checking visual consistency of a plurality of pages by:
browsing a plurality of interconnected pages;
for each browsed page, collecting at least one image data;
analysing said plurality of page images to determine a relative similarity between each of said plurality of page images; and
display said plurality of page images in a display space with said images positioned in said display space according to their common features.

7. A computer program according to claim 6, embodied in a form selected from the set:
embodied on a record medium;
stored in a computer memory;
embodied in a read-only memory;
carried on an electrical carrier signal.

8. An analysis tool for analysing a plurality of interconnected pages, said tool comprising:
a navigation component for navigating said plurality of interconnecting pages;
an image extraction component for collecting images of individual said pages addressed by said navigation component; and
an analysis component for ordering said plurality of page images in a display space according to at least one visual data inherent in each of said page images.

9. The analysis tool as claimed in claim 8, wherein said navigation component is operable to navigate over a set of browsable routes in a plurality of interconnected pages.

10. The analysis tool as claimed in claim 8 or 9, further comprising:
a visual display driver for displaying said plurality of page images in at least one dimension according to at least one parameter.

11. The analysis tool as claimed in claim 8 or 9, further comprising:
a multi dimensional visual display driver, for generating a multi-dimensional visual display in which each said dimension corresponds to a respective visual parameter.

12. A method of analysing a plurality of interconnected pages, said method comprising:
navigating said plurality of interconnected pages;
extracting at least one image of individual said pages encountered during said navigation;
collecting a set of said extracted page images; and
ordering said set of extracted page images in a display space according to at least one visual parameter inherent in each of said extracted page images.

13. A visual display generation means, comprising:
means for generating a 2-dimensional visual display screen;
means for assigning a first parameter to a first position axis of said display;
means for assigning a second parameter to a second position axis of said display; and
means for assigning a plurality of page images to said 2-dimensional visual display screen, according to a relative position of each of said page images along said first and second position axes.

14. A method of assigning page images to a 2-dimensional screen display, said method comprising:
generating a 2-dimensional visual display;
assigning a first parameter to a first position axis of said display;
assigning a second parameter to a second position axis of said display; and
assigning a plurality of page images to said 2-dimensional display, according to a relative position of each of said page images along said first and second position axes.

15. A computer program comprising program instructions for causing a computer entity to:
generate a 2-dimensional visual display view;
assign a first parameter to a first position axes of said display view;
assign a second parameter to a second position axes of said display view; and
assign a plurality of page images to said 2-dimensional display view according to a relative position of each of said page images along said first and second position axes.

16. A computer program according to claim 15, embodied in a form selected from the set:
embodied on a record medium;
stored in a computer memory;
embodied in a read-only memory;
carried on an electrical carrier signal.

17. A method of visualising a domain comprising a plurality of interconnected pages, said method comprising:
collecting a plurality of images from said domain;
positioning said plurality of images in a display space, wherein a position of each said image in said display space is determined by a visual content of said image; and
displaying said plurality of images according to their positions in said display space.

18. A computer program comprising program instructions for causing a computer entity to visualise a domain comprising a plurality of interconnected pages by:
collecting a plurality of images from said domain;
position said plurality of images in a display space, wherein a position of each said image in said display space is determined by a visual content of said image; and
display said plurality of images according to their portions in said display space.

19. A computer program according to claim 18, embodied in a form selected from the set:
embodied on a record medium;
stored in a computer memory;
embodied in a read-only memory;
carried on an electrical carrier signal.

20. A method of collecting a plurality of interconnected pages, said method comprising:
following a plurality of links from at least one initial page;
loading or downloading a page linked to from at least one collected page;
comparing a visual feature of said loaded page with visual features of collected pages; and
determining from said comparison of visual features of said loaded page with the visual features of collected pages, whether or not to follow any links from said loaded page.

21. The method as claimed in claim 20, wherein:
if a said loaded page is sufficiently similar to previously collected pages; any links from the loaded page may be followed

22. The method as claimed in claim 20 wherein said plurality of links comprise browsable routes.

23. The method as claimed in claim 20, wherein:
if a visual parameter of a said loaded page image is sufficiently dissimilar to visual images of collected pages, then terminating a search for further pages from any links provided on said loaded page.

24. A computer program comprising program code instructions for causing a computer entity to operate for:
following a plurality of links from at least one initial page;
loading or downloading a page image of at least one encountered page;
comparing a visual feature of said loaded page with visual features of collected pages; and
depending upon a visual similarity of said collected pages and said loaded page determining whether or not to follow a link from said loaded page to at least one further page.

25. A computer program according to claim 24, embodied in a form selected from the set:
embodied on a record medium;
stored in a computer memory;
embodied in a read-only memory;
carried on an electrical carrier signal.

26. Apparatus for analysing a plurality of interconnected pages, said apparatus comprising:
a page reference storage component for storing at least one page reference of an initial page; and
an analysis component for comparing a visual feature of a loaded or downloaded page with visual features of said stored pages.

27. The apparatus as claimed in claim 26, wherein said analysis component is operable such that:
if said loaded pages are of sufficiently similarly to the collected pages, said analysis component determines that links from said loaded page should be followed.

28. The method as claimed in claim 26, wherein said analysis component is operable to determine that:
if a visual parameter of said loaded page image is sufficiently dissimilar to a visual image of said collected pages, then to terminate a search for further pages accessible over at least one link provided on said downloaded page.

29. A method of analysing a plurality of pages in a domain, said method comprising:
identifying a parameter which is common to said plurality of pages; and
assigning said parameter to a dimension in a display space.

30. The method as claimed in claim 29 comprising:
identifying a plurality of parameters, each said parameter being common to a plurality of said pages;
assigning each said parameter to a corresponding respective dimension in said display space; and
positioning said plurality of web pages in said display space, according to said assigned parameters.

31. The method as claimed in claim 29, wherein, a said parameter is composed from a set including:
average, median or mode: hue, saturation and brightness of regions of an image;
colour contrast or balance within and between regions of an image

32. A method for checking a visual consistency of a plurality of interconnected pages, said method comprising:
browsing said plurality of interconnected pages;
for each individual page, collecting a sequence of a plurality of images from said page;
analysing a plurality of collected image sequences collected from a plurality of said pages; and
displaying said plurality of page images in a display space, with said images positioned relative to each other in said display space according to the similarities of their respective image sequences.

33. A computer program comprising program instructions for causing a computer entity to:
for each of a plurality of individual pages, collecting a dynamic sequence of a plurality of images from said page;
analysing a plurality of collected dynamic image sequences collected from said plurality of pages; and
displaying a plurality of page images in a display space, with said page images positioned relative to each other in said display space according to the similarities of their respective dynamic image sequences.

34. A computer program comprising program instructions for causing a computer entity to create a display which arranges a plurality of interconnected pages according to visual parameters exhibited by those pages.
